(19) United States
(12) Patent Application Publication
(10) Pub. No.: US 2016/0075833 A1
(43) Pub. Date: Mar. 17, 2016

(54) POLYARYLETHERSULFONE COPOLYMERS

(71) Applicant: BASF SE, Ludwigshafen (DE)

(72) Inventors: Martin WEBER, Maikammer (DE); Thomas WEISS, Ilvesheim (DE); Christian MALETZKO, Altrip (DE)

(73) Assignee: BASF SE, Ludwigshafen (DE)

(21) Appl. No.: 14/888,316

(22) PCT Filed: Apr. 30, 2014
(86) PCT No.: PCT/EP2014/058880

§ 371 Date: Oct. 30, 2015

(30) Foreign Application Priority Data
May 2, 2013 (EP) 13166191.0

(51) Int. Cl. C08G 75/23

(52) U.S. Cl. CPC C08G 75/23

(57) ABSTRACT

The present invention relates to a method for preparing polyarylethersulfone-polyalkylene oxide block copolymers (PPC) comprising the polycondensation of a reaction mixture (R_{G}) comprising the components:
(A1) at least one aromatic dihalogen compound,
(B1) at least one aromatic dihydroxyl compound,
(B2) at least one polyalkylene oxide compound having at least one free hydroxyl group (—OH) and at least one capped hydroxyl group (—OR^{A}),
(C) at least one aprotic polar solvent and
(D) at least one metal carbonate,
   where the reaction mixture (R_{G}) does not comprise any substance which forms an azeotrope with water.

The present invention relates to a method for preparing polyarylethersulfone-polyalkylene oxide block copolymers and to the polyarylethersulfone-polyalkylene oxide block copolymers themselves.

Polyarylethersulfone polymers belong to the group of high-performance thermoplastics and are characterized by high heat distortion resistance, good mechanical properties and an inherent flame retardance.

The preparation of polyarylethersulfones can be carried out either by the so-called hydroxide method or by the so-called carbonate method. In the preparation of polyarylethersulfone polymers by the hydroxide method, the corresponding diphenolate dianion is prepared in a first step from the aromatic dihydroxyl compound. For this purpose, the aromatic dihydroxyl compound is deprotonated by a strong base such as sodium hydroxide. The deprotonation is carried out in an aprotic polar solvent such as dimethyl sulfoxide (DMSO). The deprotonation of the aromatic dihydroxyl compound releases water. For the hydroxide method it is necessary to remove the water formed as completely as possible from the diphenolate dianion. The anhydrous diphenolate dianion formed is subsequently reacted in a second step with the aromatic dihalogen compound. The polyarylethersulfone polymer is formed in the second step. For the deprotonation of the aromatic dihydroxyl compound in the first step for the preparation of polyarylethersulfone polymers by the hydroxide method, the stoichiometric ratios between the aromatic dihydroxyl compound and the sodium hydroxide used for the deprotonation must be maintained as exactly as possible. Even minor deviations in the stoichiometry can lead to a drastic reduction in the molecular weights of the polymers formed in the reaction.

The strong bases used in the hydroxide method can, in addition, further cleave the ether links formed in the polycondensation, which leads to a further decrease in the molecular weight of the polymers formed in the reaction. The preparation of polyarylethersulfone polymers by the hydroxide method is therefore prone to error and is very complex and expensive due to the measurement complexity for the exact maintenance of the stoichiometry and the two-stage synthesis.

For the carbonate method, the aromatic dihydroxyl compound and the aromatic dihalogen compound are reacted together in the presence of carbonates, preferably potassium carbonate. In general, N,N-dimethylacetamide or NMP is used here as solvent and toluene is added as azeotroping agent for the removal of water.

Before the actual polycondensation reaction in the carbonate method, an azeotrope of toluene and water is distilled off from the reaction mixture in order to form the diphenolate dianion from the aromatic dihydroxyl compound in the reaction mixture. The carbonate method has the advantage compared to the hydroxide method that the potassium carbonate used in excess as base can be used without decreasing the molecular weights of the polymers formed. The reaction control is thereby simplified in comparison with the hydroxide method. In the methods described in the prior art for preparing polyarylethersulfone polymers by the carbonate method, the use of an azeotroping agent, such as toluene, for removal of water is absolutely essential.

An overview of the preparation of polyarylethersulfone polymers by the hydroxide method and by the carbonate method is given, for example, in J. E. McGrath et al., POLYMER 25, 1984, pp. 1827 to 1836.

Due to the good biocompatibility of polyarylethersulfone polymers, these polymers are also used as materials for producing dialysis and filter systems. For many applications, the low hydrophilicity of the polyarylethersulfone polymers is, however, a disadvantage.

Methods are described in the literature to increase the hydrophilicity of polyarylethersulfone polymers, in which hydrophilic units, such as polyalkylene oxides, are incorporated into polyarylethersulfone polymers.

For instance, F. Hancock, Macromolecules 1996, 29, pp. 7619 to 7621 describes a method for preparing polyarylethersulfone-polyethylene oxide block copolymers. The preparation is carried out by the carbonate method. For this, monomethyl polyethylene glycol (Me-PEG), bisphenol A and 4,4′-dichlorodiphenyl sulfone are reacted in the presence of potassium carbonate and a solvent mixture of N-methylpyrrolidone and toluene. It is essential for the reaction that the water of reaction formed is removed. For this purpose, the water of reaction is removed as an azeotrope of water and toluene at temperatures in the range of 150 to 160° C., before the actual polycondensation reaction sets in at temperatures between 180 and 190° C. A polyarylethersulfone-polyethylene oxide block copolymer is obtained comprising Me-PEG units as end groups of a polyarylethersulfone block.

EP 0 739 925 also describes the preparation of polyarylethersulfone-polyalkylene oxide block copolymers. The preparation is carried out by the hydroxide method. For this purpose, bisphenol A is initially deprotonated in the presence of sodium hydroxide to produce the corresponding diphenolate dianion. The deprotonation is carried out in dimethyl sulfoxide in the presence of chlorobenzene as azeotroping agent. In order to obtain the diphenolate dianion in anhydrous form, water is removed as an azeotrope with chlorobenzene. The anhydrous diphenolate dianion of bisphenol A is then reacted with dichlorodiphenyl sulfone.

U.S. Pat. No. 5,700,902 describes a method for preparing polyarylethersulfone-polyethylene oxide block copolymers by the carbonate method. In this case, monomethyl polyethylene glycol (Me-PEG) together with bisphenol A and dichlorodiphenyl sulfone are reacted in the presence of potassium carbonate. A mixture of N-methylpyrrolidone and toluene as azeotroping agent is used as solvent. The water of reaction formed is removed as an azeotrope of toluene and water.

WO 97/22406 describes a method for preparing polyarylethersulfone-polyethylene oxide block copolymers. In this method, the polyethylene glycol used to increase the hydrophilicity is activated in a first step. For the activation, the polyethylene glycol is mesylated. For this purpose, the polyethylene glycol is deprotonated with triethylamine at low temperatures in dichloromethane and subsequently reacted with methanesulfonyl chloride. In a second step, a polyarylethersulfone polymer is prepared by condensation of bisphenol A and dichlorodiphenyl sulfone. In a third step, the polyarylethersulfone polymer prepared in the second step is reacted with the activated (mesylated) polyethylene glycol, in the course of which the water of reaction is also removed as an azeotrope of toluene and water. This polycondensation is carried out in the presence of potassium carbonate as base and in N-methylpyrrolidone and toluene as solvent. The activation of the polyethylene glycol carried out in the first step is extremely expensive and complex and is therefore unsuitable for large-scale industrial synthesis.

The methods described in the prior art for preparing polyarylethersulfone-polyalkylene oxide block polymers are complex and expensive. For the known methods which are carried out by the carbonate method, the use of an azeotroping agent such as toluene or chlorobenzene is absolutely essential in order to remove the water of reaction formed. The use of these azeotroping agents leads to separation problems with the solvent mixture used in the downstream work-up steps, to relatively large recycle streams and thus to an increase in process costs. The methods described in the prior art which follow the hydroxide method are also, as described above, complex and expensive, since the synthesis must be carried out in two stages. In addition, the stoichiometry between the aromatic dihydroxyl compound and the base used must be maintained exactly. These methods are therefore prone to error and are associated with an increased measurement complexity.

In addition, the methods which use activated polyethylene glycols are disadvantageous. This is particularly due to the complexity and expense of the upstream step of activation of the polyethylene glycol used, such that these methods cannot be carried out economically on a large scale.

Moreover, in the methods described in the prior art for preparing polyarylethersulfone-polylalkylene oxide block copolymers, unsatisfactory incorporation rates of the polyalkylene oxide used to increase the hydrophilicity are usually attained. In this context, incorporation rate is understood to mean the amount of polyalkylene oxide incorporated into the polyarylethersulfone-polyalkylene oxide block copolymer obtained, based on the amount of polyalkylene oxide originally used in the polycondensation reaction. Moreover, for the methods described in the prior art for preparing polyarylethersulfone-polyalkylene oxide block copolymers, very wide molecular weight distributions are usually obtained. A measure of the molecular weight distribution is the polydispersity (Q). The polydispersity (Q) is defined as the quotient of the weight average molecular weight (M_{W}) and the number average molecular weight (Mₙ). In the methods described in the prior art, polydispersities (Q) of significantly greater than 4 are usually obtained.

The object of the present invention is therefore to provide a method for preparing polyarylethersulfone-polyalkylene oxide block copolymers (PPC), which does not have, or has only to a reduced degree, the disadvantages of the methods described in the prior art. The method should be simple to carry out, as far as possible not prone to error, and inexpensive. The method according to the invention should achieve good incorporation rates based on the polyalkylene oxide used. In addition, the method according to the invention should make available polyarylethersulfone-polyalkylene oxide block copolymers (PPC) having a narrow molecular weight distribution and therefore a low polydispersity (Q). The polyarylethersulfone-polyalkylene oxide block copolymers (PPC) should have, in addition, a high glass transition temperature and also a low fraction of impurities such as azeotroping agent.

The object is achieved according to the invention by a method for preparing polyarylethersulfone-polyalkylene oxide block copolymers (PPC) comprising the polycondensation of a reaction mixture (R_{G}) comprising the components:
(A1) at least one aromatic dihalogen compound,
(B1) at least one aromatic dihydroxyl compound,
(B2) at least one polyalkylene oxide compound having at least one free hydroxyl group (—OH) and at least one capped hydroxyl group (—OR^{A}),
(C) at least one aprotic polar solvent and
(D) at least one metal carbonate,
   where the reaction mixture (R_{G}) does not comprise any substance which forms an azeotrope with water.

It has been found that polyarylethersulfone-polyalkylene oxide block copolymers (PPC) having a lower polydispersity (Q) are obtainable by the method according to the invention. This is surprising in that, in the methods described in the prior art, the use of an azeotroping agent is described as a mandatory requirement. In the method according to the invention, polyarylethersulfone-polyalkylene oxide block copolymers (PPC) are also accessible comprising 4,4′-dihydroxybiphenyl or 4,4′-dihydroxydiphenylsulfone as aromatic dihydroxy compound. In this manner it is possible to prepare polyarylethersulfone-polyalkylene oxide block copolymers (PPC) comprising less bisphenol A than the polymers described in the prior art. It is also possible to prepare polyarylethersulfone-polyalkylene oxide block copolymers (PPC) which are free of bisphenol A, i.e. the use of bisphenol A as monomer is dispensed with in the preparation thereof. This is advantageous since bisphenol A is toxicologically harmful.

### Reaction Mixture (R_{G})

For the preparation of the polyarylethersulfone-polyalkylene oxide block copolymer (PPC) according to the invention, a reaction mixture (R_{G}) comprising the components (A1), (B1), (B2), (C) and (D) described above is reacted. The components (A1), (B1) and (B2) enter into a polycondensation reaction.

Component (C) acts as solvent. Component (D) acts as base to deprotonate the components (B1) and (B2) during the condensation reaction.

Reaction mixture (R_{G}) is understood to mean the mixture that is used in the method according to the invention for preparing the polyarylethersulfone-polyalkylene oxide block copolymers (PPC). In the present case, all details given with respect to the reaction mixture (R_{G}) thus relate to the mixture that is present prior to the polycondensation. The polycondensation takes place during the method according to the invention, in which the reaction mixture (R_{G}) reacts by polycondensation of components (A1), (B1) and (B2) to give the target product, the polyarylethersulfone-polyalkylene oxide block copolymer (PPC). The mixture obtained after the polycondensation, which comprises the polyarylethersulfone-polylalkylene oxide block polymer (PPC) target product, is also referred to as product mixture (P_{G}).

The components of the reaction mixture (R_{G}) are generally reacted concurrently. The individual components may be mixed in an upstream step and subsequently be reacted. It is also possible to feed the individual components into a reactor in which these are mixed and are then reacted.

In the method according to the invention, the individual components of the reaction mixture (R_{G}) are generally reacted concurrently. The reaction is preferably conducted in one stage. This means that the deprotonation of components (B1) and (B2) and also the condensation reaction between the components (A1) and (B1) and (B2) takes place in a single reaction stage without isolation of the intermediate products, for example the deprotonated species of components (B1) or (B2).

The method according to the invention is carried out according to the so-called carbonate method. The method according to the invention is not carried out according to the so-called hydroxide method. This means that the method according to the invention is not carried out in two stages with isolation of phenolate anions. In a preferred embodiment, the reaction mixture (R_{G}) is essentially free from alkali metal hydroxides and alkaline earth metal hydroxides. The term “essentially free”, in the present case, is understood to mean that the reaction mixture (R_{G}) comprises less than 100 ppm, preferably less than 50 ppm, of alkali metal hydroxides and alkaline earth metal hydroxides, based on the total weight of the reaction mixture (R_{G}). The reaction mixture (R_{G}) is essentially free from sodium hydroxide and potassium hydroxide.

### Component (A1)

The reaction mixture (R_{G}) comprises at least one aromatic dihalogen compound as component (A1). The term “at least one aromatic dihalogen compound”, in the present case, is understood to mean exactly one aromatic dihalogen compound and also mixtures of two or more aromatic dihalogen compounds. The reaction mixture (R_{G}) preferably comprises at least one aromatic dihalosulfone compound as component (A1). The aromatic dihalogen compounds (component (A1)) are particularly preferably dihalodiphenyl sulfones.

The present invention therefore also relates to a method in which the reaction mixture (R_{G}) comprises at least one dihalodiphenyl sulfone as component (A1).

The component (A1) is preferably used as a monomer. This means that the reaction mixture (R_{G}) comprises component (A1) as a monomer and not as a prepolymer.

The reaction mixture (R_{G}) comprises preferably at least 50% by weight of an aromatic dihalosulfone compound, preferably a dihalodiphenyl sulfone compound, as component (A1), based on the total weight of component (A1) in the reaction mixture (R_{G}).

Preferred dihalodiphenyl sulfones are the 4,4′-dihalodiphenyl sulfones. Particular preference is given to 4,4′-dichlorodiphenyl sulfone, 4,4′-difluorodiphenyl sulfone and 4,4′-dibromodiphenyl sulfone as component (A1). 4,4′-Dichlorodiphenyl sulfone and 4,4′-difluorodiphenyl sulfone are particularly preferred, while 4,4′-dichlorodiphenyl sulfone is most preferred.

The present invention therefore also relates to a method wherein component (A1) comprises at least 50% by weight of at least one aromatic dihalosulfone compound selected from the group consisting of 4,4′-dichlorodiphenyl sulfone and 4,4′-difluorodiphenyl sulfone, based on the total weight of component (A1) in the reaction mixture (R_{G}).

In a particularly preferred embodiment, component (A1) comprises at least 80% by weight, preferably at least 90% by weight, more preferably at least 98% by weight, of an aromatic dihalosulfone compound selected from the group consisting of 4,4′-dichlorodiphenyl sulfone and 4,4′-difluorodiphenyl sulfone, based on the total weight of component (A1) in the reaction mixture (R_{G}).

In a further particularly preferred embodiment, component (A1) consists essentially of at least one aromatic dihalosulfone compound selected from the group consisting of 4,4′-dichlorodiphenyl sulfone and 4,4′-difluorodiphenyl sulfone. “Consisting essentially of”, in the present case, is understood to mean that component (A1) comprises more than 99% by weight, preferably more than 99.5% by weight, particularly preferably more than 99.9% by weight, of at least one aromatic dihalosulfone compound selected from the group consisting of 4,4′-dichlorodiphenyl sulfone and 4,4′-difluorodiphenyl sulfone, based in each case on the total weight of component (A1) in the reaction mixture (R_{G}). In these embodiments, 4,4′-dichlorodiphenyl sulfone is particularly preferred as component (A1).

In a further particularly preferred embodiment, component (A1) consists of 4,4′-dichlorodiphenyl sulfone.

### Component (B1)

The reaction mixture (R_{G}) comprises at least one aromatic dihydroxyl compound as component (B1). The term “at least one aromatic dihydroxyl compound”, in the present case, is understood to mean exactly one aromatic dihydroxyl compound and also mixtures of two or more aromatic dihydroxyl compounds. The aromatic dihydroxyl compounds used are typically compounds having two phenolic hydroxyl groups. Since the reaction mixture (R_{G}) comprises a metal carbonate, the hydroxyl groups of component (B1) in the reaction mixture may be present partially in deprotonated form. The same applies to component (B2).

Component (B1) is preferably used as a monomer. This means that the reaction mixture (R_{G}) comprises component (B1) as a monomer and not as a prepolymer.

Suitable aromatic dihydroxyl compounds (component (B1)) are, for example, selected from the group consisting of 4,4′-dihydroxybiphenyl and 4,4′-dihydroxydiphenyl sulfone. In principle, other aromatic dihydroxyl compounds can also be used, such as bisphenol A (IUPAC name: 4,4′-(propane-2,2-diyl)diphenol)). The advantageous effects according to the invention, i.e. the low polydispersity (Q) and the high incorporation rates of polyalkylene oxide, are particularly pronounced, however, using dihydroxyl compounds (component (B1)) selected from the group consisting of 4,4′-dihydroxybiphenyl and 4,4′-dihydroxydiphenyl sulfone.

In the methods described in the prior art, exclusively polyarylethersulfone-polyalkylene oxide block copolymers (PPC) comprising bisphenol A as aromatic dihydroxyl compound and a dihalodiphenyl sulfone as aromatic dihalogen compound are prepared. The polyarylethersulfone-polyalkylene oxide block copolymers (PPC) prepared in the prior art, comprising bisphenol A as aromatic dihydroxyl compound, are also referred to as polysulfone-polyalkylene oxide block copolymers.

In one embodiment of the present invention, the reaction mixture (R_{G}) does not comprise any bisphenol A.

In a further embodiment, the reaction mixture (R_{G}) comprises not more than 5% by weight, preferably not more than 2.5% by weight, particularly preferably not more than 1% by weight and particularly not more than 0.1% by weight of bisphenol A, based in each case on the total weight of the aromatic dihydroxy compounds (component B1) present in the reaction mixture (R_{G}).

The reaction mixture (R_{G}) particularly preferably comprises not more than 5% by weight, preferably not more than 2.5% by weight, particularly preferably not more than 1% by weight and particularly not more than 0.1% by weight of bisphenol A, based in each case on the total weight of the reaction mixture (R_{G}). Most preferably, the reaction mixture (R_{G}) does not comprise any bisphenol A.

Component (B1) generally comprises at least 50% by weight, preferably at least 80% by weight, particularly preferably at least 90% by weight and especially at least 98% by weight of an aromatic dihydroxyl compound selected from the group consisting of 4,4′-dihydroxybiphenyl and 4,4′-dihydroxydiphenyl sulfone, based on the total weight of component (B1) in the reaction mixture (R_{G}). 4,4′-Dihydroxydiphenyl sulfone is particularly preferred as aromatic dihydroxyl compound.

The present invention therefore also relates to a method wherein component (B1) comprises at least 50% by weight of an aromatic dihydroxyl compound selected from the group consisting of 4,4′-dihydroxybiphenyl and 4,4′-dihydroxydiphenyl sulfone, based on the total weight of component (B1) in the reaction mixture (R_{G}).

In a particularly preferred embodiment, component (B1) consists essentially of at least one aromatic dihydroxyl compound selected from the group consisting of 4,4′-dihydroxybiphenyl and 4,4′-dihydroxydiphenyl sulfone. “Consisting essentially of”, in the present case, is understood to mean that component (B1) comprises more than 99% by weight, preferably more than 99.5% by weight, particularly preferably more than 99.9% by weight, of an aromatic dihydroxyl compound selected from the group consisting of 4,4′-dihydroxybiphenyl and 4,4′-dihydroxydiphenyl sulfone, based in each case on the total weight of component (B1) in the reaction mixture (R_{G}).

In a particularly preferred embodiment, component (B1) consists of 4,4′-dihydroxydiphenyl sulfone.

### Component (B2)

The reaction mixture (R_{G}) comprises at least one polyalkylene oxide compound having at least one free hydroxyl group (—OH) and at least one capped hydroxyl group (—OR^{A}) as component (B2). “At least one polyalkylene oxide compound” is understood to mean, according to the invention, either exactly one polyalkylene oxide compound or mixtures of two or more polyalkylene oxide compounds.

Compounds derived from polyalkylene oxides are suitable as component (B2). Suitable polyalkylene oxides according to the invention are those polyalkylene oxides which are obtainable by polymerisation of ethylene oxide, 1,2-propylene oxide, 1,2-butylene oxide, 2,3-butylene oxide, 1,2-pentene oxide, 2,3-pentene oxide or mixtures of these monomers. Particularly preferred polyalkylene oxides are those having two hydroxyl groups. Such polyalkylene oxides are also referred to as polyether diols. Suitable polyalkylene oxides generally comprise 1 to 500 alkylene oxide units. Preference is given to alkylene oxides comprising 2 to 300, particularly preferably 3 to 150, especially preferably 5 to 100 and most preferably 10 to 80 alkylene oxide units.

To obtain the polyalkylene oxide compound (component (B2)) starting from the polyalkylene oxides described above, at least one free hydroxyl group (—OH) of the alkylene oxide is formally converted to a capped hydroxyl group (—OR^{A}). Suitable methods for preparing component (B2) are known to those skilled in the art. Component (B2) can be prepared, for example, by ionic polymerisation, in which the alkylene oxide monomers are polymerised in the presence of an alkoxide anion (R^{A}O⁻). The alkoxide anion (R^{A}O⁻) serves here as starter for the polymerisation reaction. In this embodiment, the capped hydroxyl group (—OR^{A}) is introduced into component (B2) via the alkoxide anion (R^{A}O⁻). In the preferred case, where a polyalkylene oxide compound which is derived from a polyalkylene oxide having two hydroxyl groups is used as component (B2), the polyalkylene oxide compound used as component (B2) therefore comprises a free hydroxyl group (—OH) and a capped hydroxyl group (—OR^{A}).

A free hydroxyl group (—OH), in the present case, is understood to mean hydroxyl groups, i.e. alcohol functions, in an actual sense. Hydroxyl groups can be deprotonated in the presence of bases, forming the corresponding alkoxide anion (—O⁻).

A capped hydroxyl group (—OR^{A}), in the present case, is understood to mean a group comprising a capping group (R^{A}), which is bonded to the oxygen of the former OH group via an ether link. The capped hydroxyl group (—OR^{A}) is therefore formally derived by an etherification from a free hydroxyl group (—OH). Suitable capping groups (R^{A}) are generally those having no free OH groups themselves. Suitable capping groups (R^{A}) can be aliphatic or aromatic residues.

Examples are alkyl groups, substituted alkyl groups, phenyl groups or substituted phenyl groups. Preferred suitable capping groups (R^{A}) are selected, for example, from the group consisting of C₁-, C₂-, C₃-, C₄-, C₅-, C₆-, C₇-, C₈-, C₉-, C₁₀-, C₁₁-, C₁₂-, C₁₃-, C₁₄-, C₁₅-, C₁₆-, C₁₇-, C₁₈-, C₁₉-, C₂₀-, C₂₁- and C₂₂-alkyl groups. Particularly preferred capping groups are selected from the group consisting of methyl, ethyl, propyl, butyl, hexyl, C₁₆-alkyl and C₁₈-alkyl.

Suitable capping groups (R^{A}) may be linear or branched alkyl residues. Preference is given to linear alkyl groups as capping groups (R^{A}). In a further embodiment of the present invention, a compound of the general formula (I) is used as polyalkylene oxide compound (component (B2))

R^{A}—(OCH₂—CHR^{B})ₖ—OH (I)

where
R^{A} is an aliphatic or aromatic residue,
R^{B} is hydrogen or an aliphatic or aromatic residue
k is a number in the range from 1 to 500.

The general formula (I) shows suitable polyalkylene oxide compounds which may be used as component (B2) in the method according to the invention. The free OH group (—OH) is shown at the “right hand end” of formula (I). The capped hydroxyl group (—OR^{A}) is shown at the “left hand end” of formula (I). Preference is given to compounds of the general formula (I) as component (B2), where
R^{A} is selected from the group consisting of methyl, ethyl, propyl, butyl, hexyl, C₁₆-alkyl and C₁₈-alkyl,
R^{B} is selected from the group consisting of hydrogen, methyl, ethyl, phenyl and
k is a number in the range from 10 to 80.

Particular preference is given to compounds of the general formula (I) as component (B2), where
R^{A} is selected from the group consisting of methyl, ethyl, propyl, butyl, hexyl, C₁₆-alkyl and C₁₈-alkyl,
R^{B} is hydrogen and
k is a number in the range from 10 to 80.

As already stated above, the polyalkylene oxide compounds used as component (B2) are formally derived from polyalkylene oxides.

The polyalkylene oxides from which the component (B2) is formally derived generally have a number average molecular weight (Mₙ) of at least 200 g/mol. Preference is given to polyalkylene oxides having a number average molecular weight (Mₙ) in the range of 200 to 50 000 g/mol, particularly preferably in the range of 400 to 40 000 g/mol and particularly preferably in the range of 600 to 20 000 g/mol, from which the component (B2) is formally derived.

The polyalkylene oxides from which the component (B2) is formally derived are preferably polyethylene glycol, polypropylene glycol and also copolymers of polyethylene glycol and polypropylene glycol.

Particular preference is given to polyethylene glycol homopolymers having a number average molecular weight (Mₙ) in the range of 600 to 20 000 g/mol.

The molecular weights of the polyalkylene oxides from which the component (B2) is formally derived are determined by measuring the OH number. The OH number of the polyalkylene glycols (polyalkylene oxides) used is determined by means of potentiometric titration. The OH groups are initially esterified by means of an acylation mixture of acetic anhydride and pyridine. The excess of acetic anhydride is determined by titration with 1 molar KOH. From the consumption of KOH, the amount of acetic anhydride and the initial sample weight, the OH number can then be calculated.

Since a metal carbonate is present in the reaction mixture (R_{G}) as component (D), the polyalkylene oxide compounds (component (B2)) in the reaction mixture (R_{G}) may be present partially in deprotonated form.

The polyalkylene oxide compounds which are present in the reaction mixture (R_{G}) and have at least one free hydroxyl group (—OH) and at least one capped hydroxyl group (—OR^{A}) are added to the reaction mixture (R_{G}) as such. This means that the polyalkylene oxides are not used in activated form. “Activated form” is understood to mean hydroxyl groups which have been converted by a chemical reaction into a leaving group, such as a mesylate group. The capped hydroxyl group (—OR^{A}) is neither an “activated form” nor a leaving group.

Component (B2) generally comprises at least 50% by weight of a polyalkylene oxide compound of which the polyalkylene oxide fraction is obtainable by polymerisation of ethylene oxide, 1,2-propylene oxide, 1,2-butylene oxide, 2,3-butylene oxide, 1,2-pentene oxide, 2,3-pentene oxide or mixtures of these monomers, based on the total weight of component (B2) in the reaction mixture (R_{G}).

The present invention therefore also relates to a method wherein component (B2) comprises at least 50% by weight of a polyalkylene oxide compound of which the polyalkylene oxide fraction is obtainable by polymerisation of ethylene oxide, 1,2-propylene oxide, 1,2-butylene oxide, 2,3-butylene oxide, 1,2-pentene oxide, 2,3-pentene oxide or mixtures of these monomers, based on the total weight of component (B2) in the reaction mixture (R_{G}).

Preferred components (B2) are polyalkylene oxide compounds of which the polyalkylene oxide fraction is obtainable by polymerisation of ethylene oxide, 1,2-propylene oxide or mixtures of ethylene oxide and 1,2-propylene oxide.

In a particularly preferred embodiment of the present invention, component (B2) comprises at least 80% by weight, preferably at least 90% by weight, more preferably at least 98%, by weight of a polyalkylene oxide compound having one free hydroxyl group (—OH) and one capped hydroxyl group (—OR^{A}), and whose polyalkylene oxide fraction is obtainable by polymerisation of ethylene oxide, 1,2-propylene oxide or mixtures of ethylene oxide and 1,2-propylene oxide, based in each case on the total weight of component (B2) in the reaction mixture (R_{G}).

In a further particularly preferred embodiment, component (B2) consists essentially of a polyalkylene oxide compound of which the polyalkylene oxide fraction is obtainable by polymerisation of ethylene oxide, propylene oxide or mixtures of ethylene oxide and propylene oxide. “Consisting essentially of”, in the present case, is understood to mean that component (B2) comprises more than 99% by weight, preferably more than 99.5% by weight, particularly preferably more than 99.9% by weight, of at least one polyalkylene oxide compound of which the polyalkylene oxide fraction is obtainable by polymerisation of ethylene oxide, 1,2-propylene oxide or mixtures of ethylene oxide and 1,2-propylene oxide, based in each case on the total weight of component (B2) in the reaction mixture (R_{G}).

Polyethylene glycol having a number average molecular weight (Mₙ) in the range of 600 to 20 000 g/mol is particularly preferred as the polyalkylene oxide fraction in this embodiment.

### Component (C)

The reaction mixture (R_{G}) comprises at least one aprotic polar solvent as component (C). “At least one aprotic polar solvent”, according to the invention, is understood to mean exactly one aprotic polar solvent and also mixtures of two or more aprotic polar solvents.

Suitable aprotic polar solvents are, for example, anisole, dimethylformamide, dimethyl sulfoxide, sulfolane, N-methyl-2-pyrrolidone, N-ethyl-2-pyrrolidone and also mixtures of these solvents.

Preferred aprotic polar solvents are N-methyl-2-pyrrolidone, N-ethyl-2-pyrrolidone and also mixtures of these solvents. N-Methyl-2-pyrrolidone is particularly preferred as aprotic polar solvent.

The present invention therefore also relates to a method wherein the reaction mixture (R_{G}) comprises N-methyl-2-pyrrolidone as component (C).

In a preferred embodiment, component (C) comprises at least 50% by weight of at least one solvent selected from the group consisting of N-methyl-2-pyrrolidone and N-ethyl-2-pyrrolidone, based on the total weight of component (C) in the reaction mixture (R_{G}). N-Methyl-2-pyrrolidone is particularly preferred as component (C).

In a further embodiment, component (C) consists essentially of N-methyl-2-pyrrolidone. “Consisting essentially of”, in the present case, is understood to mean that component (C) comprises more than 99% by weight, particularly preferably more than 99.5% by weight, particularly preferably more than 99.9% by weight, of at least one aprotic polar solvent selected from the group consisting of N-methyl-2-pyrrolidone and N-ethyl-2-pyrrolidone, with preference given to N-methyl-2-pyrrolidone.

In a preferred embodiment, component (C) consists of N-methyl-2-pyrrolidone. N-Methyl-2-pyrrolidone is also referred to as NMP or N-methylpyrrolidone.

The reaction mixture (R_{G}), according to the invention, does not comprise any substance which forms an azeotrope with water. Water of reaction is formed in the method according to the invention in the condensation reaction between the components (A1), (B1) and (B2). In the methods described in the prior art, it is necessary to add an azeotropic agent in order to remove the water of reaction formed in the condensation reaction as an azeotrope.

“Azeotrope”, according to the invention, is understood to mean a mixture of water and one or more further substances which cannot be separated by distillation. “Azeotrope” is therefore understood to mean, according to the invention, a mixture of water and one or more substances which, on phase transition from liquid to gaseous, behaves as if it were a pure substance. In a preferred embodiment, the reaction mixture (R_{G}) does not comprise any toluene or chlorobenzene.

### Component (D)

The reaction mixture (R_{G}) comprises at least one metal carbonate as component (D). The metal carbonate is preferably anhydrous. Preference is given to alkali metal carbonates and/or alkaline earth metal carbonates as metal carbonates. At least one metal carbonate selected from the group consisting of sodium carbonate, potassium carbonate and calcium carbonate is particularly preferred as metal carbonate. Potassium carbonate is particularly preferred.

In a preferred embodiment, the metal carbonate is essentially anhydrous, i.e. it comprises not more than 1% by weight, preferably not more than 0.5% by weight and particularly preferably not more than 0.1% by weight of water, based in each case on the total weight of the metal carbonate (component D). The quantities of water here refer to the quantities before the method according to the invention is carried out.

In a preferred embodiment, component (D) consists essentially of potassium carbonate. “Consisting essentially of”, in the present case, is understood to mean that the component (D) comprises more than 99% by weight, preferably more than 99.5% by weight, particularly preferably more than 99.9% by weight, of potassium carbonate, based in each case on the total weight of component (D) in the reaction mixture (R_{G}).

In a particularly preferred embodiment, component (D) consists of potassium carbonate.

Potassium carbonate having a volume weighted average particle size of less than 200 μm is particularly preferred as potassium carbonate. The volume weighted average particle size of the potassium carbonate is determined in a suspension of potassium carbonate in N-methyl-2-pyrrolidone using a particle size analyser.

In a preferred embodiment, the reaction mixture (R_{G}) does not comprise any alkali metal hydroxides or alkaline earth metal hydroxides.

Particular preference is given to a reaction mixture (R_{G}) in which
component (A1) comprises at least 50% by weight, preferably at least 90% by weight, particularly preferably at least 95% by weight, of 4,4′-dichlorodiphenyl sulfone, based on the total weight of component (A1) in the reaction mixture (R_{G}),
component (B1) comprises at least 50% by weight, preferably at least 90% by weight, particularly preferably at least 95% by weight, of 4,4′-dihydroxydiphenyl sulfone, based on the total weight of component (B1) in the reaction mixture (R_{G}),
component (B2) comprises at least 50% by weight, preferably at least 90% by weight, particularly preferably at least 95% by weight, of a polyalkylene oxide compound of the general formula (I), where
   R^{A} is selected from the group consisting of methyl, ethyl, propyl, butyl, hexyl, C₁₆-alkyl and C₁₈-alkyl,
   R^{B} is hydrogen and
   k is in the range of 10 to 80, based on the total weight of component (B2) in the reaction mixture (R_{G}),
component (C) consists essentially of N-methylpyrrolidone and
component (D) consists essentially of potassium carbonate,
   where the reaction mixture (R_{G}) does not comprise any substance which forms an azeotrope with water.

The present invention therefore also relates to a method that component (A1) is 4,4′-dichlorodiphenyl sulfone, component (B1) is 4,4′-dihydroxydiphenyl sulfone and component (B2) is a polyalkylene oxide compound of which the polyalkylene oxide fraction is polyethylene glycol.

The ratios of components (A1), (B1) and (B2) in the reaction mixture (R_{G}) may vary within wide ranges. The reaction mixture (R_{G}) generally comprises 0.7 to 0.995 mol of component (B1) and 0.005 to 0.3 mol of component (B2) per 1 mole of component (A1).

The present invention therefore also relates to a method wherein the reaction mixture (R_{G}) comprises 0.7 to 0.995 mol of component (B1) and 0.005 to 0.3 mol of component (B2) per one mole of component (A1).

The present invention also relates to a method for preparing polyarylethersulfone-polyalkylene oxide block copolymers (PPC) comprising the polycondensation of a reaction mixture (R_{G}) comprising the components:
(A1) at least one aromatic dihalogen compound comprising at least 95% by weight of 4,4′-dichlorodiphenylsulfone, based on the total weight of the component (A1) in the reaction mixture (R_{G}),
(B1) at least one aromatic dihydroxy compound comprising at least 95% by weight of 4,4′-dihydroxydiphenylsulfone, based on the total weight of the component (B1) in the reaction mixture (R_{G}),
(B2) at least one polyalkylene oxide compound having at least one free hydroxy group (—OH) and at least one capped hydroxy group (—OR^{A}), which comprises at least 95% by weight of a polyalkylene oxide compound of the general formula (I),

R^{A}—(OCH₂—CHR^{B})_{K}—OH

in which
R^{A} is selected from the group consisting of methyl, ethyl, propyl, butyl, hexyl, C₁₆-alkyl and C₁₈-alkyl,
R^{B} is hydrogen and
k is in the range from 10 to 80, based on the total weight of the component (B2) in the reaction mixture (R_{G}),
(C) at least one aprotic polar solvent consisting essentially of N-methylpyrrolidone and
(D) at least one metal carbonate consisting essentially of potassium carbonate,
   wherein the reaction mixture (R_{G}) does not comprise any substance which forms an azeotrope with water, wherein the reaction mixture (R_{G}) comprises at most 5% by weight of bisphenol A, based on the total weight of the reaction mixture (R_{G}), and wherein the reaction mixture (R_{G}) comprises 0.7 to 0.995 mol of component (B1) and 0.005 to 0.3 mol of component (B2) per 1 mol of component (A1).

Polyarylethersulfone-Polyalkylene Oxide Block Copolymer (PPC)

To prepare the polyarylethersulfone-polyalkylene oxide block copolymer (PPC) according to the invention, the reaction mixture (R_{G}) is reacted under the conditions of the so-called carbonate method. The reaction (polycondensation reaction) is generally conducted at temperatures in the range of 80 to 250° C., preferably in the range of 100 to 220° C., where the upper limit of the temperature is determined by the boiling point of the solvent at standard pressure (1013.25 mbar). The reaction is generally carried out at standard pressure. The reaction is preferably carried out over a time interval of 2 to 12 hours, particularly in the range of 3 to 10 hours.

The isolation of the polyarylethersulfone-polyalkylene oxide block copolymer (PPC) obtained according to the invention may be carried out, for example, by precipitation of the polymer solution in water or mixtures of water with other solvents. The precipitated PPC can subsequently be extracted with water and then dried. In one embodiment of the invention, the precipitate can also be taken up in an acidic medium. Suitable acids are, for example, organic or inorganic acids, for example carboxylic acids such as acetic acid, propionic acid, succinic acid or citric acid, and mineral acids such as hydrochloric acid, sulfuric acid or phosphoric acid.

The method according to the invention achieves high incorporation rates of the polyalkylene oxide compound (component (B2)). Incorporation rates with respect to the polyalkylene oxide compound, in the present case, are understood to mean the amount of the polyalkylene oxide compound which is present in covalently bound form in the polyarylethersulfone-polyalkylene oxide block copolymer (PPC) following the polycondensation, based on the amount of the polyalkylene oxide compound (component (B2)) originally present in the reaction mixture (R_{G}). The method according to the invention achieves incorporation rates of 85%, preferably ≧90%.

The present invention therefore also relates to a method for preparing polyarylethersulfone-polyalkylene oxide block copolymers (PPC), in which at least 85% by weight, preferably at least 90% by weight, of component (B2) present in the reaction mixture (R_{G}) are incorporated into the polyarylethersulfone-polyalkylene oxide block copolymer (PPC).

Polyarylethersulfone-polyalkylene oxide block copolymers (PPC) having low polydispersities (Q) and high glass transition temperatures (T_{g}) are obtained by the method according to the invention. The polyarylethersulfone-polyalkylene oxide block copolymers, moreover, have very low amounts of impurities, for example azeotroping agents such as toluene or chlorobenzene.

The present invention therefore also provides a polyarylethersulfone-polyalkylene oxide block copolymer (PPC) which is obtainable by the method according to the invention. The polyarylethersulfone-polyalkylene oxide block copolymer (PPC) generally has a polydispersity (Q) of ≦4, preferably ≦3.5.

The polydispersity (Q) is defined as the quotient of the weight average molecular weight (M_{W}) and the number average molecular weight (Mₙ). In a preferred embodiment, the polydispersity (Q) of the polyarylethersulfone-polyalkylene oxide block copolymer (PPC) is in the range of 2.0 to ≦4, preferably in the range of 2.0 to 5 3.5.

The weight average molecular weight (M_{W}) and the number average molecular weight (Mₙ) are measured by means of gel permeation chromatography.

The polydispersity (Q) and the average molecular weights of the polyarylethersulfone-polyalkylene oxide block copolymer (PPC) were measured by means of gel permeation chromatography (GPC) in dimethylacetamide (DMAc). The mobile phase (eluent) used was DMAc comprising 0.5% by weight of lithium bromide. The concentration of the polyarylethersulfone-polyalkylene oxide block copolymers (PPC solution) was 4 mg per milliliter of solution. After filtration (pore size 0.2 μm), 100 μl of this solution were injected into the GPC system. Four different columns (heated to 80° C.) were used for separation (GRAM precolumn, GRAM 30A, GRAM 1000A, GRAM 1000A; separation material: polyester copolymers ex. PSS). The GPC system was operated at a flow rate of 1 ml per minute. A DRI-Agilent 1100 was used as the detection system. A PMMA standard ex. PSS having a molecular weight Mₙ in the range of 800 to 1 820 000 g/mol was used for the calibration.

The polyarylethersulfone-polyalkylene oxide block copolymer (PPC) obtainable by the method according to the invention generally has weight average molecular weights (M_{W}) of 10 000 to 150 000 g/mol, preferably in the range of 15 000 to 120 000 g/mol, particularly preferably in the range of 20 000 to 90 000 g/mol. The weight average molecular weights (M_{W}) are measured by means of gel permeation chromatography (GPC). The measurement is carried out as described above.

The copolymers according to the invention have a raised glass transition temperature (T_{g}). The measurement of the glass transition temperature (T_{g}) was carried out in a DSC 2000 (TA Instruments) at a heating rate of 20 K/min. For the measurement, approximately 5 mg of the substance were sealed in an aluminum crucible. In the first heating run, the samples are heated to 250° C., then rapidly cooled to −100° C. and then, in the second heating run, heated to 250° C. at 20 K/min. The respective T_{g} value is determined from the second heating run.

In addition, the invention relates to polyarylethersulfone-polyalkylene oxide block copolymers (PPC) comprising on average one to two polyalkylene oxide blocks and one polyarylethersulfone block. The polyarylethersulfone-polyalkylene oxide block copolymers (PPC) preferably comprise on average two polyalkylene oxide blocks and one polyarylethersulfone block.

The polyarylethersulfone blocks originate from the polycondensation reaction between the components (A1) and (B1). The polyalkylene oxide blocks originate from component (B2).

The present invention is further elucidated by the following working examples without limiting it.

### Components Used:

DCDPS: 4,4′-dichlorodiphenyl sulfone,
DHDPS: 4,4′-dihydroxydiphenyl sulfone,
Me-PEG 2000: α-methyl-ω-hydroxypolyethylene glycol, number average molecular weight Mₙ 2000 g/mol,
Potassium carbonate: K₂CO₃, anhydrous, average particle size 32.4 μm,
NMP: N-methylpyrrolidone, anhydrous,
PPC: Polyarylethersulfone-polyethylene oxide block copolymer.

The fraction of volatile components, such as toluene, was determined by headspace gas chromatography. T_{g}, Mₙ, M_{W} and Q were determined as described above.

The viscosity number VN was measured according to DIN ISO 1628-1 in a 1% by weight NMP solution.

The incorporation ratio (the incorporation rate) of PEG was determined by ¹H-NMR in CDCl₃. In this case, the signal intensity of the aliphatic PEG units is considered in relation to the intensity of the aromatic units from the polyarylether. This gives a value for the PEG fraction in mol %, which can be converted into % by weight with the known molar weights of the corresponding structural units. The incorporation rates listed in Table 1 are then calculated as the quotient of the determined weight fraction of PEG and the theoretically calculated value.

The isolation of the polyarylethersulfone-polyalkylene oxide block copolymers (PPC) is carried out by dripping an NMP solution of the polymers into demineralised water at room temperature. The drop height is 0.5 m. The throughput is about 2.5 l per hour. The beads obtained are then extracted with water (water throughput 160 l/h) at 85° C. for twenty hours: The beads are then dried at a temperature below the glass transition temperature T_{g} to a residual moisture content of less than 0.1% by weight.

### EXAMPLE 1

### Inventive Preparation of PPC in the Absence of an Azeotroping Agent

In a 4 liter reactor equipped with internal thermometer, gas inlet tube and reflux condenser with water separator, 574.16 g of DCDPS, 490.33 g of DHDPS, 80 g of Me-PEG 2000 and 290.24 of potassium carbonate were suspended in 1053 ml of NMP under a nitrogen atmosphere. The mixture is heated to 190° C. within 1 hour. The reaction period is considered to be the residence time at 190° C. The water of reaction is distilled off and the fill level kept constant by addition of NMP during the reaction. After a reaction period of 6 h, the reaction is stopped by dilution with cold NMP (1947 ml). Nitrogen is then introduced (20 l per hour) and the mixture is cooled. The potassium chloride produced is filtered off.

### EXAMPLE 2

### Inventive Preparation of PPC in the Absence of an Azeotroping Agent

In a 4 liter reactor equipped with internal thermometer, gas inlet tube and reflux condenser with water separator, 574.16 g of DCDPS, 487.83 g of DHDPS, 100 g of Me-PEG 2000 and 290.24 of potassium carbonate were suspended in 1053 ml of NMP under a nitrogen atmosphere. The mixture is heated to 190° C. within 1 hour. The reaction period is considered to be the residence time at 190° C. The water of reaction is distilled off and the fill level kept constant by addition of NMP during the reaction. After a reaction period of 6 h, the reaction is stopped by dilution with cold NMP (1947 ml). Nitrogen is then introduced (20 l per hour) and the mixture cooled. The potassium chloride produced is filtered off.

### COMPARATIVE EXAMPLE 3

### Preparation of PPC in the Presence of Toluene as Azeotroping Agent

In a 4 liter reactor equipped with internal thermometer, gas inlet tube, reflux condenser and water separator, 574.16 g of DCDPS, 490.33 g of DHDPS, 80 g of Me-PEG 2000 and 290.24 g of potassium carbonate were suspended in 1053 mm of NMP under a nitrogen atmosphere. 250 ml of toluene were added as azeotroping agent. The mixture was heated to 160° C. and maintained at this temperature for 1 h. During this time an azeotrope of toluene and water is distilled off (amount of toluene distilled off about 100 ml). The mixture is then heated to 175° C. and maintained at this temperature for 1 h. The temperature is then increased to 190° C. and further toluene is distilled off. The reaction period is considered to be the residence time at a temperature of 190° C. After a reaction period of 6 h, the reaction is stopped by dilution with cold NMP (1947 ml). Nitrogen is then introduced (20 l per hour) and the mixture cooled. The potassium chloride produced is filtered off.

### COMPARATIVE EXAMPLE 4

### Preparation of PPC in the Presence of Toluene as Azeotroping Agent

In a 4 liter reactor equipped with internal thermometer, gas inlet tube, reflux condenser and water separator, 574.16 g of DCDPS, 487.83 g of DHDPS, 100 g of Me-PEG 2000 and 290.24 g of potassium carbonate was suspended in 1053 mm of NMP under a nitrogen atmosphere. 250 ml of toluene were added as azeotroping agent. The mixture was heated to 160° C. and maintained at this temperature for 1 h. During this time an azeotrope of toluene and water is distilled off (amount of toluene distilled off about 100 ml). The mixture is then heated to 175° C. and maintained at this temperature for 1 h. The temperature is then increased to 190° C. and further toluene is distilled off. The reaction period is considered to be the residence time at a temperature of 190° C. After a reaction period of 6 h, the reaction is stopped by dilution with cold NMP (1947 ml). Nitrogen is then introduced (20 l per hour) and the mixture cooled. The potassium chloride produced is filtered off.

The properties of the polyarylethersulfone-polyethylene oxide block copolymers (PPC) obtained are given in the following table.

TABLE 1

| Example | 1 | 2 | C3 | C4 |
|---|---|---|---|---|
| VN [ml/g] | 62.1 | 57.4 | 63.2 | 61.2 |
| PEG fraction [wt %] | 8.0 | 9.7 | 7.7 | 9.4 |
| Q [M_{W}/Mₙ] | 2.9 | 3.2 | 4.1 | 4.3 |
| Incorporation rate [%] | 96.0 | 97.0 | 95.0 | 96.0 |
| T_{g} [° C.] | 174 | 165 | 168 | 158 |
| Toluene [ppm] | 0 | 0 | 5 | 7 |

In the method according to the invention, polyarylethersulfone-polyethylene oxide block copolymers having a low polydispersity (Q) are obtainable. In addition, the block copolymers are characterized by high glass transition temperatures (T_{g}). In the method according to the invention, moreover, good incorporation rates and good viscosity numbers (VN) are achieved.

1. A method for preparing a polyarylethersulfone-polyalkylene oxide block copolymer, the method comprising polycondensing a reaction mixture comprising:
(A1) at least one aromatic dihalogen compound;
(B1) at least one aromatic dihydroxyl compound;
(B2) at least one polyalkylene oxide compound having at least one free hydroxyl group (—OH) and at least one capped hydroxyl group (—OR^{A});
(C) at least one aprotic polar solvent; and
(D) at least one metal carbonate,
wherein the reaction mixture does not comprise any substance which forms an azeotrope with water.

2. The method according to claim 1, wherein the aromatic dihalogen compound (A1) comprises at least 50% by weight of at least one aromatic dihalosulfone compound selected from the group consisting of 4,4′-dichlorodiphenyl sulfone and 4,4′-difluoro diphenyl sulfone, based on the total weight of the aromatic dihalogen compound (A1) in the reaction mixture.

3. The method according to claim 1, wherein the aromatic dihydroxyl compound (B1) comprises at least 50% by weight of an aromatic dihydroxyl compound selected from the group consisting of 4,4′-dihydroxybiphenyl and 4,4′-dihydroxydiphenyl sulfone, based on the total weight of the aromatic dihydroxyl compound (B1) in the reaction mixture.

4. The method according to claim 1, wherein the polyalkylene oxide compound (B2) comprises at least 50% by weight of a polyalkylene oxide compound of which the polyalkylene oxide fraction is obtained by polymerizing ethylene oxide, 1,2-propylene oxide, 1,2-butylene oxide, 2,3-butylene oxide, 1,2-pentene oxide, 2,3-pentene oxide or mixtures thereof, based on the total weight of the polyalkylene oxide compound (B2) in the reaction mixture.

5. The method according to claim 1, wherein the reaction mixture comprises a polyalkylene oxide compound (B2) of formula (I):
R^{A}—(OCH₂—CHR^{B})ₖ—OH
wherein:
R^{A} is an aliphatic or aromatic residue;
R^{B} is hydrogen or an aliphatic or aromatic residue; and
k is a number in the range from 1 to 500.

6. The method according to claim 1, wherein the reaction mixture comprises N-methyl-2-pyrrolidone as the aprotic polar solvent (C).

7. The method according to claim 1, wherein the reaction mixture comprises potassium carbonate as the metal carbonate (D).

8. The method according to claim 1, wherein:
the aromatic dihalogen compound (A1) is 4,4′-dichlorodiphenyl sulfone;
the aromatic dihydroxyl compound (B1) is 4,4′-dihydroxydiphenyl sulfone; and
the polyalkylene oxide compound (B2) is a polyalkylene oxide compound of which the polyalkylene oxide fraction is polyethylene glycol.

9. The method according to claim 1, wherein the reaction mixture comprises 0.7 to 0.995 mol of the aromatic dihydroxyl compound (B1) and 0.005 to 0.3 mol of the polyalkylene oxide compound (B2) per one mole of the aromatic dihalogen compound (A1).

10. The method according to claim 1, wherein the polyarylethersulfone-polyalkylene oxide block copolymer has a polydispersity (Q) of ≦4, where Q is defined as the quotient of the weight average molecular weight M_{W} and the number average molecular weight Mₙ.

11. The method according to claim 1, wherein at least 85% by weight of the polyalkylene oxide compound (B2) present in the reaction mixture are incorporated into the polyarylethersulfone-polyalkylene oxide block copolymer.

12. A polyarylethersulfone-polyalkylene oxide block copolymer obtained by the method of claim 1.

13. The polyarylethersulfone-polyalkylene oxide block copolymer of claim 12, which has a weight average molecular weight (M_{W}) ranging from 10 000 to 150 000 g/mol.

14. The polyarylethersulfone-polyalkylene oxide block copolymer of claim 12, which has a polydispersity (Q) ranging from 2.0 to ≦4.
